(19) United States
(12) Patent Application Publication
(10) Pub. No.: US 2026/0222684 A1
(43) Pub. Date: Jul. 30, 2026

(54) IMAGING ASSISTANCE SYSTEM, IMAGING ASSISTANCE METHOD, AND NON-TRANSITORY COMPUTER READABLE MEDIUM

(71) Applicant: NEC Corporation, Tokyo (JP)

(72) Inventor: Kousuke NOGAMI, Tokyo (JP)

(73) Assignee: NEC Corporation, Tokyo (JP)

(21) Appl. No.: 19/444,599

(22) Filed: Jan. 9, 2026

(30) Foreign Application Priority Data
Jan. 30, 2025 (JP) 2025-013909

(51) Int. Cl. H04N 23/68; G06T 7/77; H04N 23/611

(52) U.S. Cl. CPC H04N 23/6811; G06T 7/77; H04N 23/611; G06T 2207/20076; G06T 2207/30196

(57) ABSTRACT

An imaging assistance system according to the present disclosure assists image capturing by a camera of a mobile body. The system includes a trajectory creation unit that creates a movement trajectory of a hand of a worker from an image, a generation unit that generates frequency time information including a frequency at which the hand of the worker is positioned at each position included in a movement trajectory of the hand and a time during which the hand of the worker is positioned at the position, a work target estimation unit that estimates positions and shapes of work targets of the worker based on the frequency time information, and an imaging position/posture determination unit that determines an imaging position and a posture of the mobile body by the camera in such a way that the worker and the work targets are included in a same view angle.

### INCORPORATION BY REFERENCE

This application is based upon and claims the benefit of priority from Japanese patent application No. 2025-013909, filed on January 30, 2025, the disclosure of which is incorporated herein in its entirety by reference.

### TECHNICAL FIELD

The present disclosure relates to an imaging assistance system, an imaging assistance method, and a program.

### BACKGROUND ART

In a production site, since a worker works at any place, there is a case where the work of the worker is photographed using a mobile body. The image captured by the mobile body is used for analysis of work, for example, analysis regarding time required for work, omission of a work process, and the like. In the case of performing such an analysis, if the mobile body captures an image in which it is not possible to determine which is the work target, useful information cannot be obtained.

For example, JP 2022-187215 A discloses a motion determining device that detects an interaction between a person and an object from one image and recognizes the person and the object related to the person.

### SUMMARY

Here, in a production site, a worker often works on a work target using a tool or works by assembling a plurality of parts to the work target. In such a production site, it cannot be said that the motion determining device disclosed in JP 2022-187215 A can necessarily appropriately recognize the worker and the work target. As a result, it has been difficult to appropriately analyze the work.

In view of the above-described problems, an example object of the present disclosure is to provide an imaging assistance system, an imaging assistance method, and a program capable of acquiring an image capable of appropriately analyzing a work.

An imaging assistance system according to an example aspect of the present disclosure assists image capturing by a camera of a mobile body, the imaging assistance system including

a trajectory creation unit that creates a movement trajectory of a hand of a worker from an image,

a generation unit that generates frequency time information including a frequency at which the hand of the worker is positioned at each position included in a movement trajectory of the hand and a time during which the hand of the worker is positioned at the position,

a work target estimation unit that estimates a position and a shape of a work target of the worker based on the frequency time information, and

an imaging position/posture determination unit that determines an imaging position and a posture of the mobile body by the camera in such a way that the worker and the work target are included in a same angle of view.

An imaging assistance method according to an example aspect of the present disclosure assists image capturing by a camera of a mobile body, the imaging assistance method causing a computer to execute

creating a movement trajectory of a hand of a worker from an image,

generating frequency time information including a frequency at which the hand of the worker is positioned at each position included in a movement trajectory of the hand and a time during which the hand of the worker is positioned at the position,

estimating a position and a shape of a work target of the worker based on the frequency time information, and

determining an imaging position and a posture of the mobile body by the camera in such a way that the worker and the work target are included in a same angle of view.

A program according to an example aspect of the present disclosure is an imaging assistance program for assisting image capturing by a camera of a mobile body, the imaging assistance program causing a computer to execute

creating a movement trajectory of a hand of a worker from an image,

generating frequency time information including a frequency at which the hand of the worker is positioned at each position included in a movement trajectory of the hand and a time during which the hand of the worker is positioned at the position,

estimating a position and a shape of a work target of the worker based on the frequency time information, and

determining an imaging position and a posture of the mobile body by the camera in such a way that the worker and the work target are included in a same angle of view.

According to the present disclosure, it is possible to provide an imaging assistance system, an imaging assistance method, and a program capable of acquiring an image capable of appropriately analyzing a work.

### BRIEF DESCRIPTION OF THE DRAWINGS

FIG. 1 is a block diagram illustrating an imaging assistance system according to the present disclosure;

FIG. 2 is a flowchart illustrating an imaging assistance method according to the present disclosure;

FIG. 3 is a block diagram illustrating an imaging assistance system according to the present disclosure;

FIG. 4 is a schematic diagram illustrating movement trajectories of a left hand and a right hand and a cumulative frequency in each divided space;

FIG. 5 is a schematic diagram illustrating an example of an extraction result of extracting a cumulative frequency in each divided space;

FIG. 6 is a diagram illustrating imaging candidate positions of a worker and a work target;

FIG. 7 is a flowchart illustrating the imaging assistance method according to the present disclosure;

FIG. 8 is a block diagram illustrating a mobile imaging robot;

FIG. 9 is a diagram illustrating a motion of the mobile imaging robot at the production site;

FIG. 10 is a schematic diagram illustrating a state in which the mobile imaging robot performs imaging;

FIG. 11 is a block diagram illustrating an imaging assistance system according to the present disclosure;

FIG. 12 is a diagram illustrating imaging candidate positions and trajectories of a worker;

FIG. 13 is a flowchart illustrating the imaging assistance method according to the present disclosure; and

FIG. 14 is a block diagram illustrating a configuration example of a mobile body according to the present disclosure.

### EXAMPLE EMBODIMENT

Hereinafter, the present disclosure will be described according to example embodiments, but the disclosure described in the claims is not limited to the following example embodiments. Not all of the configurations described in the example embodiment are essential as means for solving the problem. In the drawings, the same elements are denoted by the same reference numerals, and repeated description will be omitted as necessary.

### First Example Embodiment

### Imaging Assistance System

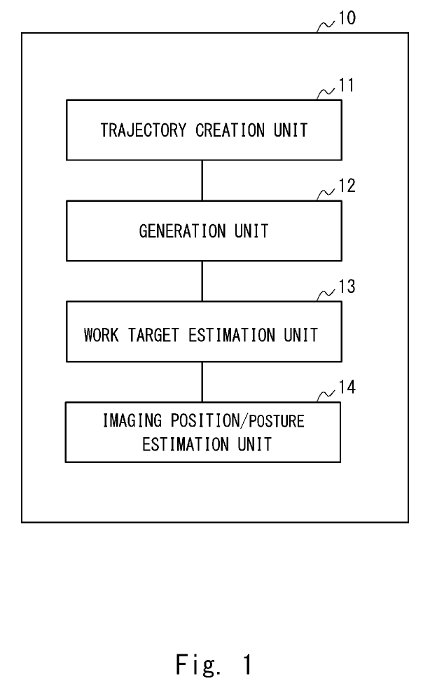

Hereinafter, a configuration of an imaging assistance system according to the present disclosure will be described with reference to FIG. 1. FIG. 1 is a block diagram illustrating the imaging assistance system according to the present disclosure. As illustrated in FIG. 1, an imaging assistance system 10 includes a trajectory creation unit 11, a generation unit 12, a work target estimation unit 13, and an imaging position/posture determination unit 14. The imaging assistance system 10 is a system that assists image capturing by a camera of the mobile body.

The trajectory creation unit 11 creates a movement trajectory of the hand of the worker from the image. The image includes a worker and a work target. The work target is a target on which a worker is performing work. For example, in a case where a worker is performing an operation of assembling parts to an engine using a tool, the work target is the engine.

The generation unit 12 generates frequency time information including the frequency of the hand of the worker being positioned at each position included in the movement trajectory of the hand and the time of the hand of the worker being positioned at each position. For example, it is assumed that the worker moves the hand in the order of the positions A, B, C, and A, and draws a movement trajectory connecting the positions A, B, and C. In this case, the generation unit 12 counts that the hand is positioned at the position A twice. It is counted that the hand is positioned at each of the positions B and C once.

As another example, it is assumed that the worker moves the hand in the order of the positions A, B, and C and draws a movement trajectory connecting the positions A, B, and C. In this case, the generation unit 12 counts that the hand is positioned at the position A for 10 seconds. It is counted that the hand is positioned at each of the positions B and C for 5 seconds.

The work target estimation unit 13 estimates the position and shape of the work target of the worker based on the frequency time information. For example, the work target estimation unit 13 can estimate the position and shape of the work target with which the worker is in contact from information regarding frequency and time at each position included in the movement trajectory.

The imaging position/posture determination unit 14 decides an imaging position and a posture of the mobile body by the camera such that the worker and the work target are included in the same angle of view.

As described above, the imaging assistance system 10 according to the present disclosure estimates the position and the shape of the work target from the motion of the hand of the worker, and determines the imaging position and the posture of the mobile body by the camera such that the worker and the work target are included in the same angle of view. With such a configuration, the imaging assistance system 10 according to the present disclosure can acquire an image capable of appropriately analyzing work, for example, analyzing time required for work, omission of a work process, and the like.

The imaging assistance system 10 may be configured such that a device performs some or all of the processes of the trajectory creation unit 11, the generation unit 12, the work target estimation unit 13, and the imaging position/posture determination unit 14. That is, in the imaging assistance system 10, the processes of the trajectory creation unit 11, the generation unit 12, the work target estimation unit 13, and the imaging position/posture determination unit 14 may be executed in a distributed manner in different terminals or servers.

### Imaging Assistance Method

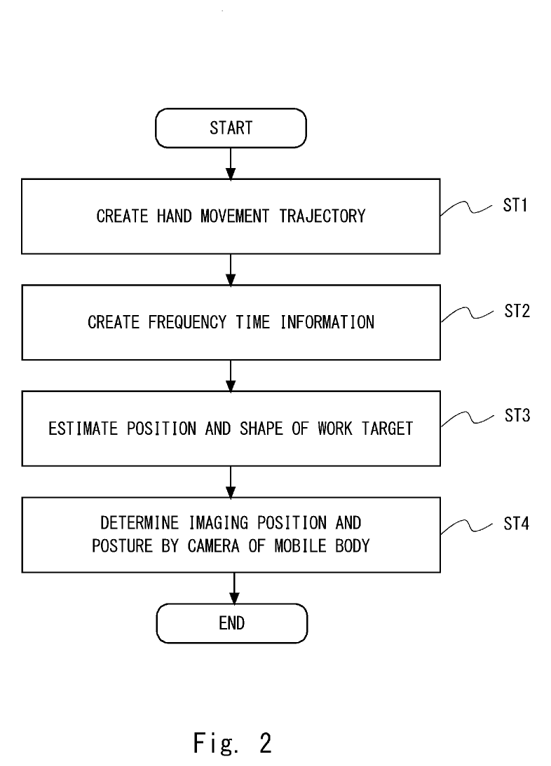

Next, an imaging assistance method according to the present disclosure will be described. FIG. 2 is a flowchart illustrating an imaging assistance method according to the present disclosure.

First, the trajectory creation unit 11 creates a movement trajectory of the hand of the worker from the image (step ST1).

Next, the generation unit 12 generates frequency time information including the frequency of the hand of the worker being positioned at each position included in the movement trajectory of the hand and the time of the hand of the worker being positioned at each position (step ST2).

Next, the work target estimation unit 13 estimates the position and shape of the work target of the worker based on the frequency time information (step ST3).

Next, the imaging position/posture determination unit 14 decides an imaging position and a posture of the mobile body by the camera such that the worker and the work target are included in the same angle of view (step ST4).

As described above, the imaging assistance method according to the present disclosure estimates the position and the shape of the work target from the motion of the hand of the worker, and determines the imaging position and the posture of the mobile body by the camera such that the worker and the work target are included in the same angle of view. With such a configuration, the imaging assistance method according to the present disclosure can acquire an image capable of appropriately analyzing work, for example, analyzing time required for work, omission of a work process, and the like.

### Second Example Embodiment

### Imaging Assistance System

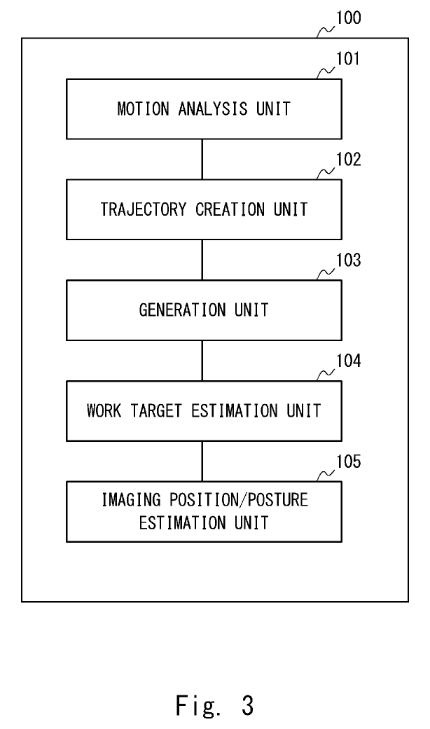

Hereinafter, a configuration of an imaging assistance system according to the present disclosure will be described with reference to FIG. 3. FIG. 3 is a block diagram illustrating the imaging assistance system according to the present disclosure. As illustrated in FIG. 3, an imaging assistance system 100 includes a motion analysis unit 101, a trajectory creation unit 102, a generation unit 103, a work target estimation unit 104, and an imaging position/posture determination unit 105.

The imaging assistance system 100 is a system that assists image capturing by the camera of the mobile body. The mobile body is, for example, an autonomous traveling robot or a drone. Hereinafter, each configuration will be described in detail. Then, an operation and an operation example of the imaging assistance system will be described.

### Motion Analysis Unit

The motion analysis unit 101 acquires an image obtained by capturing the work of the worker to be captured. The motion analysis unit 101 analyzes the acquired image. For example, the motion analysis unit 101 analyzes the skeleton of the worker included in the image, and specifies the position and movement of the hand and body of the worker. The motion analysis unit 101 may perform recognition processing of a hand or a body of the worker included in the image, and may specify each position or movement.

The motion analysis unit 101 is not limited to the above example, and a known technique for specifying the position and movement of the hand or body of the worker may be used. The body includes a part of the body such as the chest, neck, or head of the worker.

The motion analysis unit 101 performs skeleton analysis using, for example, a trained network of skeleton analysis capable of analyzing three-dimensional motion from a two-dimensional image. The motion analysis unit 101 may be configured to acquire a three-dimensional image acquired using a stereo camera or the like and perform skeleton analysis. The motion analysis unit 101 may estimate the motion of the hand that is not visible in the image from the motion of one hand in the image by skeleton analysis.

### Trajectory Creation Unit

The trajectory creation unit 102 creates a movement trajectory of the hand of the worker from the analysis result of the motion analysis unit 101. The trajectory creation unit 102 creates a movement trajectory for the worker's left hand, right hand, and both hands, for example. The trajectory creation unit 102 may determine a hand as a target for creating a trajectory according to the angle of view of the image acquired by the motion analysis unit 101.

The trajectory creation unit 102 creates a movement trajectory of the hand, for example, by extracting the position of the wrist from the analysis result of the motion analysis unit 101. The trajectory creation unit 102 may create the movement trajectory of the hand by extracting the position of any one of the palm, the wrist, and the fingers from the analysis result of the motion analysis unit 101.

In a case where the motion analysis unit 101 estimates the motion of the hand not seen in the image from the motion of one hand in the image by the skeleton analysis, the trajectory creation unit 102 may create the movement trajectories of both hands including the estimated motion of the hand.

The movement trajectory is indicated on coordinates, for example. In a case where the image acquired by the motion analysis unit 101 is a two-dimensional image, the movement trajectory is indicated using two-dimensional coordinates. In a case where the image acquired by the motion analysis unit 101 is a three-dimensional image, the movement trajectory is indicated using three-dimensional coordinates. In a case where the motion analysis unit 101 estimates a three-dimensional motion from a two-dimensional image, the movement trajectory is indicated using three-dimensional coordinates.

### Generation Unit

The generation unit 103 generates frequency time information including the frequency of the hand of the worker being positioned at each position included in the movement trajectory of the hand and the time of the hand of the worker being positioned at each position. The generation unit 103 may accumulate the frequency at which the hand of the worker is positioned at each position included in the movement trajectory of the worker for each divided space obtained by dividing the space in which the worker is positioned. The generation unit 103 may accumulate the time during which the hand of the worker is positioned at each position included in the movement trajectory of the hand of the worker for each divided space obtained by dividing the space in which the worker is positioned.

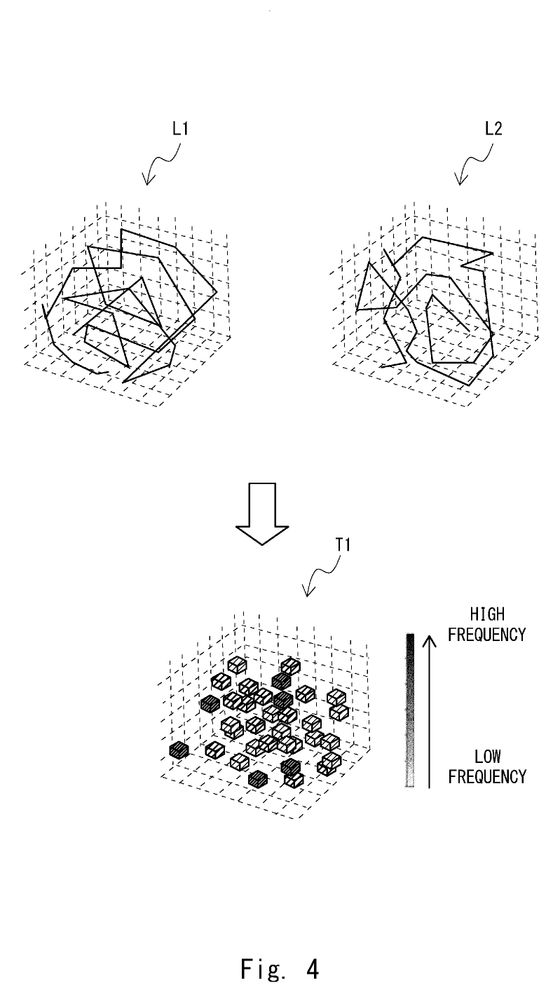

The generation unit 103 will be specifically described with reference to FIG. 4. FIG. 4 is a schematic diagram illustrating movement trajectories of the left hand and the right hand and a cumulative frequency in each divided space. FIG. 4 illustrates a divided space obtained by dividing a space including a movement trajectory L1 of the left hand and a movement trajectory R1 of the right hand into a plurality of spaces. The size of the divided space can be set to any value.

In FIG. 4, the movement trajectory L1 of the left hand and the movement trajectory R1 of the right hand are mapped in a three-dimensional space. A generation result T1 illustrated in FIG. 4 indicates the cumulative frequency at which the left hand and the right hand of the worker are positioned in each divided space. In the generation result T1 of FIG. 4, it is indicated that the value of the cumulative frequency is larger as the hatching is darker.

For example, in the generation result T1 illustrated in FIG. 4, in a certain divided space, it is counted that the left hand and the right hand of the worker are positioned 10 times, and the cumulative frequency is 10 times. In the other divided spaces, it is counted that the left hand and the right hand of the worker are positioned five times, and the cumulative frequency is five times.

In this manner, the generation unit 103 accumulates the frequency at which the hand of the worker is positioned in the divided space to generate the cumulative frequency. In other words, it can be said that the generation unit 103 performs analysis based on the frequency and time in the space from the movement trajectory of the hand of the worker. Here, the frequency has been described as an example, but the same applies to time.

The generation unit 103 may generate the generation result T1 as follows. The generation unit 103 generates a generation result of the cumulative frequency at which the left hand of the worker is positioned in each divided space from the movement trajectory L1 of the left hand of the worker. The generation unit 103 generates a generation result of the cumulative frequency at which the right hand of the worker is positioned in each of the divided spaces from the movement trajectory R1 of the right hand of the worker. Then, the generation unit 103 adds the generation results of the left hand and the right hand to generate the generation result T1.

### Work Target Estimation Unit

The work target estimation unit 104 estimates the position and shape of the work target of the worker based on the frequency time information. Specifically, the work target estimation unit 104 estimates the position and shape of the work target of the worker by extracting a divided space having a cumulative frequency equal to or higher than a predetermined value. The work target estimation unit 104 may estimate the position and shape of the work target of the worker by extracting a divided space in which the cumulative time is equal to or more than a predetermined value. The predetermined value can be set to any value. The predetermined value may be determined according to the reproduction time of the image acquired by the motion analysis unit 101 or the ratio of the number of frames.

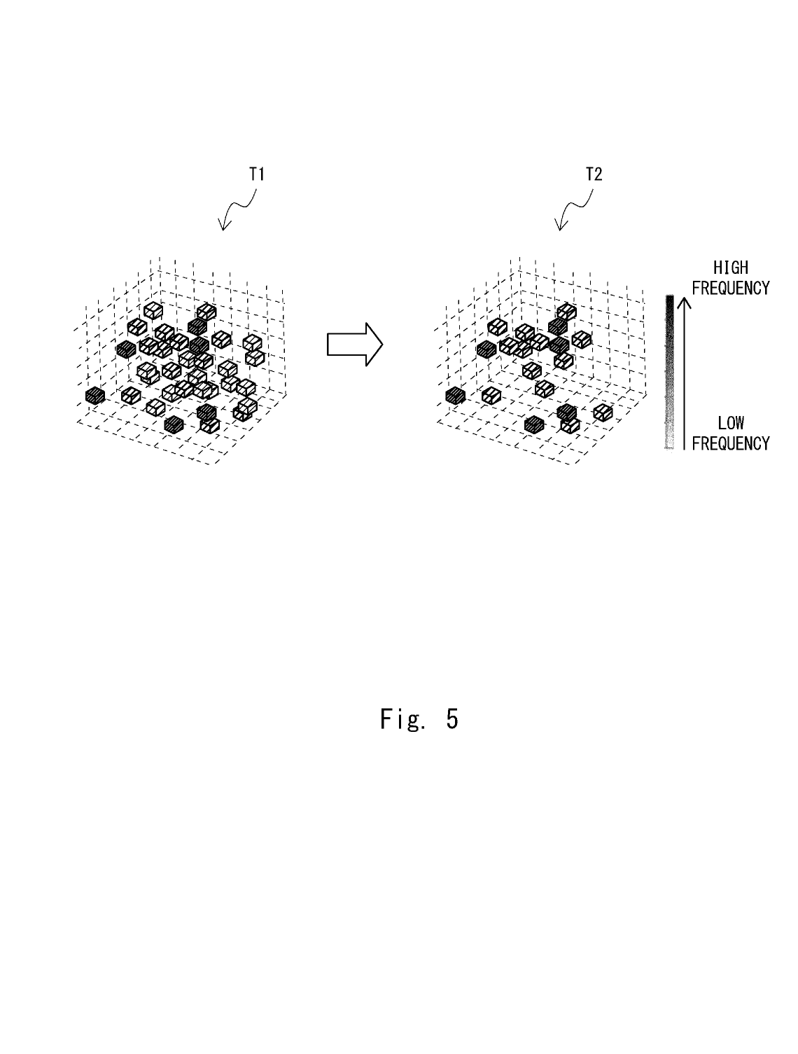

The work target estimation unit 104 will be specifically described with reference to FIG. 5. FIG. 5 is a schematic diagram illustrating an example of an extraction result of extracting a cumulative frequency in each divided space. The generation result T1 illustrated in FIG. 5 is similar to the generation result T1 in FIG. 4.

As illustrated in FIG. 5, the work target estimation unit 104 extracts a divided space having a cumulative frequency equal to or higher than a predetermined value from the generation result T1, and generates an extraction result T2. In other words, the work target estimation unit 104 performs filtering using the set predetermined value. The work target estimation unit 104 estimates the position and shape of the work target from the extraction result T2. The work target estimation unit 104 estimates, for example, the position, shape, and size of the engine being assembled by the worker.

Here, an example in which the work target estimation unit 104 estimates the position and shape of the work target from the generation result T1 indicating the cumulative frequency at which the left hand and the right hand are positioned in each divided space has been described. However, the present disclosure is not limited thereto, and the work target estimation unit 104 may estimate the position and shape of the work target from the generation result indicating the cumulative frequency at which one of the left hand and the right hand is positioned.

### Imaging Position/Posture Determination Unit

The imaging position/posture determination unit 105 decides an imaging position and a posture of the mobile body by the camera such that at least the worker and the work target are included in the same angle of view. The imaging position/posture determination unit 105 may further decide the imaging position and the posture such that the overlapping area between the worker and the work target is reduced.

In other words, the imaging position/posture determination unit 105 determines the imaging position and the posture of the mobile body by the camera by evaluating whether the worker and the work target enter the same angle of view, whether the worker and the work target do not enter blind spots, or whether the blind spots of the worker and the work target are minimized.

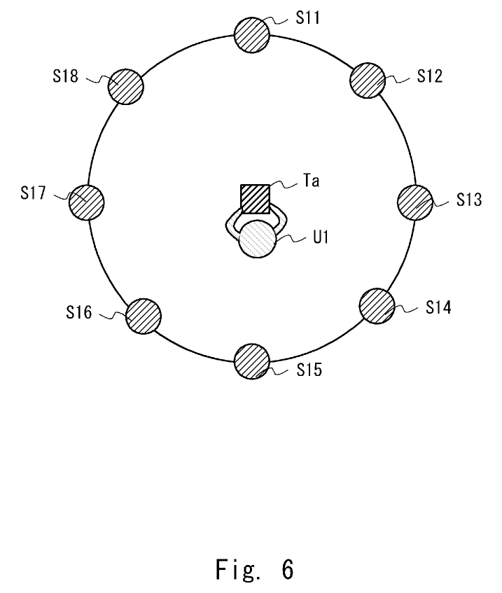

The imaging position/posture determination unit 105 will be described more specifically with reference to FIG. 6. FIG. 6 is a diagram illustrating imaging candidate positions of the worker and the work target.

### Determination of Imaging Distance

The imaging position/posture determination unit 105 determines whether the worker and the work target are included in the capturing angle of view based on the focal length of the camera of the mobile body and the distance from the camera of the mobile body to the worker and the work target.

In a case where the worker and the work target are included in the imaging angle of view, the imaging position/posture determination unit 105 determines the distance from the camera of the mobile body to the worker and the work target as the imaging distance. The imaging position/posture determination unit 105 may determine the imaging distance in consideration of the zoom function of the camera of the mobile body. By determining the imaging distance, the worker and the work target are included in the same angle of view.

### Determination of Imaging Position and Posture

As illustrated in FIG. 6, the imaging position/posture determination unit 105 creates concentric circles centered on the positions of the worker and the work target and having the imaging distance as a radius. Then, as illustrated in FIG. 6, the imaging position/posture determination unit 105 sets a plurality of imaging candidate positions S11 to S18 on concentric circles.

Then, the imaging position/posture determination unit 105 evaluates whether the worker and the work target do not enter a blind spot or whether the blind spot is the minimum at each of the imaging candidate positions S11 to S18. Specifically, the following is performed. It is assumed that the camera is directed to the worker and the work target from each of the imaging candidate positions S11 to S18.

At each of the imaging candidate positions S11 to S18, the camera of the mobile body irradiates the worker and the work target with a light beam. For example, the imaging position/posture determination unit 105 selects a portion of the worker or a plurality of points of the work target, and determines whether each point collides with a light beam.

For example, in a case where the light beam collides with the point of the work target without colliding with the worker, the imaging position/posture determination unit 105 specifies that the worker and the work target do not overlap each other. In a case where the light beam collides with the worker and does not collide with the point of the work target, the imaging position/posture determination unit 105 specifies that the worker and the work target overlap each other.

The imaging position/posture determination unit 105 determines whether capturing is possible due to collision of the light beam at each point, and calculates the number of points that can be captured. The imaging position/posture determination unit 105 determines the imaging position of the mobile body by the camera so that the number of points that can be captured is maximized.

Here, since the imaging position/posture determination unit 105 determines whether capturing is possible due to collision of the light beam at each point and calculates the number of points that can be captured, it can be said that the capturing range of the worker and the work target is calculated. The imaging position/posture determination unit 105 may determine the imaging position from among the imaging candidate positions S11 to S18 so as to reduce the area where the worker and the work target overlap, in other words, so as to maximize the capturing range of the worker and the work target. In this manner, by determining the imaging position, it is possible to perform image capturing so that the worker and the work target do not become blind spots or the blind spots are minimized. In other words, it can be said that the imaging position/posture determination unit 105 performs evaluation called ray tracing.

In the example illustrated in FIG. 6, the imaging candidate positions are 8 points, but the imaging position/posture determination unit 105 may determine the imaging position using a large number of imaging candidate positions of 8 points or more.

In the example illustrated in FIG. 6, the imaging position/posture determination unit 105 creates concentric circles of the determined imaging distance and sets a predetermined position on the concentric circle as an imaging candidate position. However, a predetermined position included in the range may be set as an imaging candidate position by adding or subtracting a constant buffer to or from the imaging distance. As a result, the motion of the worker as the imaging target can be considered.

In FIG. 6, the description has been given while the postures of the cameras directed toward the worker and the work target from the imaging candidate positions S11 to S18 are the same. The imaging position/posture determination unit 105 may determine the posture of the mobile body by the camera such that the area where the worker overlaps the work target is reduced by a similar procedure. That is, the imaging position/posture determination unit 105 may determine the capturing posture and the posture of the mobile body by the camera such that the area where the worker overlaps the work target is reduced.

### Imaging Assistance Method

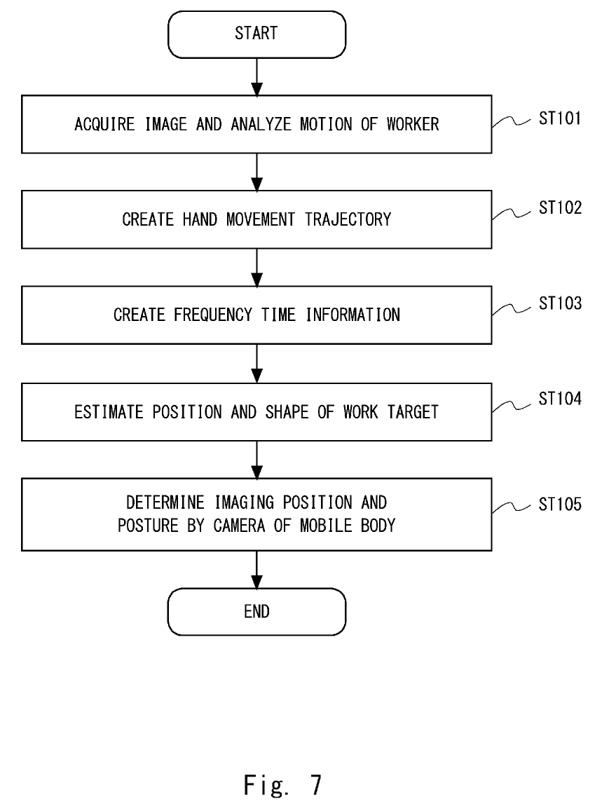

Next, an imaging assistance method according to the present disclosure will be described. FIG. 7 is a flowchart illustrating an imaging assistance method according to the present disclosure.

First, the motion analysis unit 101 acquires an image obtained by photographing the work of the worker to be photographed, and specifies the motion of the worker (step ST101). More specifically, the motion analysis unit 101 performs skeleton analysis of the worker.

Next, the trajectory creation unit 102 creates a movement trajectory of the hand of the worker from the analysis result of the motion analysis unit 101 (step ST102). More specifically, the trajectory creation unit 102 creates a movement trajectory for the worker's left hand, right hand, and both hands.

Next, the generation unit 103 generates frequency time information including the frequency of the hand of the worker being positioned at each position included in the movement trajectory of the hand and the time of the hand of the worker being positioned at each position (step ST103). More specifically, as illustrated in FIG. 4, the generation unit 103 accumulates the frequency at which the hand of the worker is positioned at each position included in the movement trajectory of the worker for each divided space obtained by dividing the space in which the worker is positioned, and generates the generation result T1.

Next, the work target estimation unit 104 estimates the position and shape of the work target of the worker based on the frequency time information (step ST104). More specifically, as illustrated in FIG. 5, the work target estimation unit 104 extracts a divided space having a cumulative frequency equal to or higher than a predetermined value from the generation result T1, and generates an extraction result T2. The work target estimation unit 104 estimates the position and shape of the work target from the extraction result T2.

Next, the imaging position/posture determination unit 105 decides an imaging position and a posture of the mobile body by the camera such that at least the worker and the work target are included in the same angle of view (step ST105). The imaging position/posture determination unit 105 determines the imaging position and the posture such that the area where the worker and the work target overlap each other is reduced.

As described above, in the imaging assistance method according to the present disclosure, the imaging position and the posture of the mobile body by the camera are determined such that the worker and the work target are included in the same angle of view. In the imaging assistance method according to the present disclosure, the imaging position and the posture of the mobile body by the camera are determined such that the worker and the work target do not become blind spots or the blind spots are minimized.

With such a configuration, the imaging assistance method according to the present disclosure can acquire an image capable of appropriately analyzing work, for example, analyzing time required for work, omission of a work process, and the like. This makes it possible to improve work efficiency and reduce work errors.

In the imaging assistance system according to the present disclosure, even in a situation where the work target of the worker cannot be specified in advance, imaging can be performed with both the worker and the work target included in the same angle of view. As a result, the operation can be appropriately analyzed.

### Example in Production Site

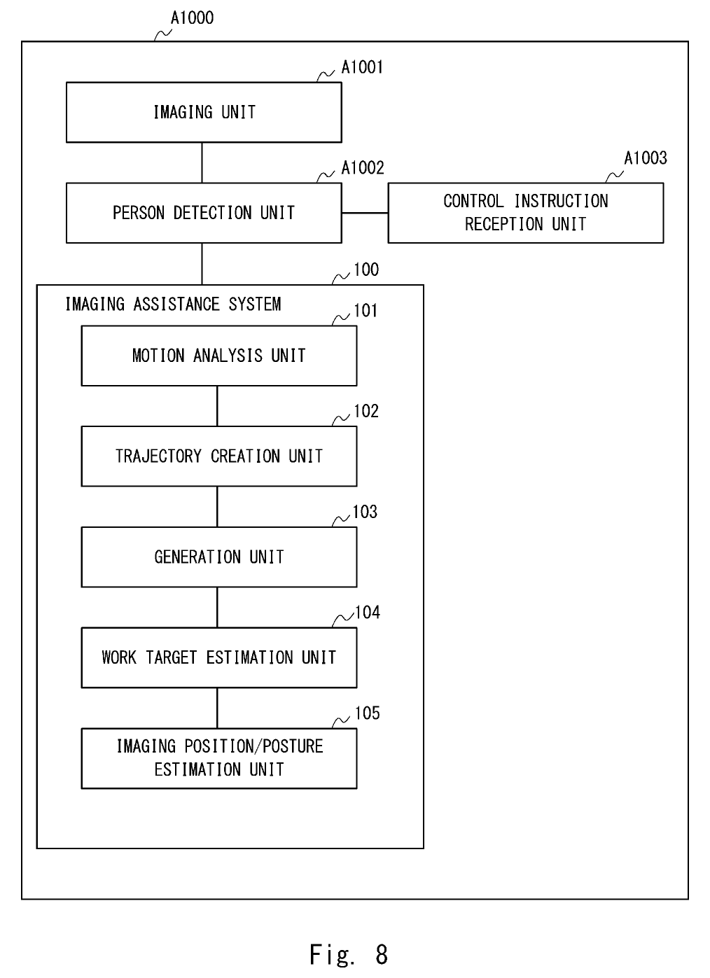

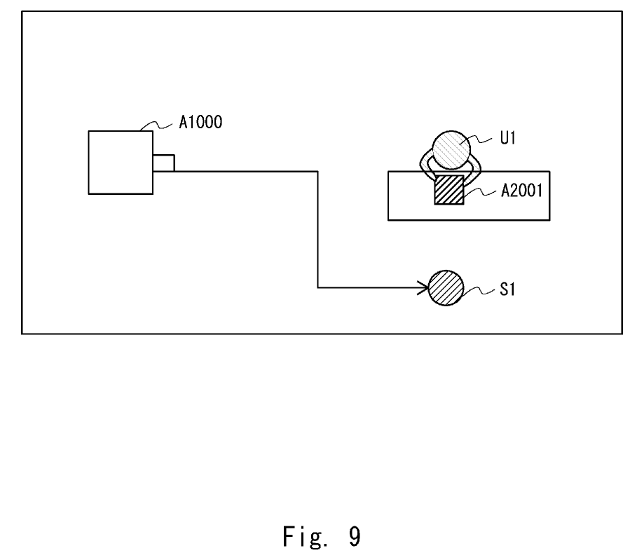

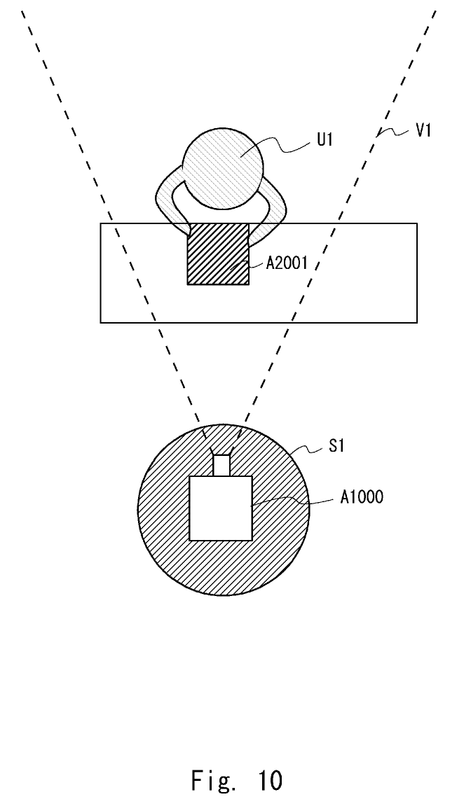

An example at a production site will be described with reference to FIGS. 8 to 10. FIG. 8 is a block diagram illustrating a mobile imaging robot. FIG. 9 is a diagram illustrating a motion of the mobile imaging robot at the production site. FIG. 10 is a schematic diagram illustrating a state in which the mobile imaging robot performs imaging.

As illustrated in FIG. 8, a mobile imaging robot A1000 includes an imaging unit A1001, a person detection unit A1002, an imaging assistance system 100, and a control instruction reception unit A1004. The mobile imaging robot A1000 illustrated in FIG. 8 uses the imaging unit A1001 at the production site to image the worker performing the assembly work and the work target.

The mobile imaging robot A1000 stores the map of the production site illustrated in FIG. 9, and instructs the control instruction reception unit A1004 on the moving position and the stop posture to maintain the instructed posture and stop at the instruction position.

In FIG. 9, the mobile imaging robot A1000 patrols and captures an image using the imaging unit A1001. In FIG. 9, the mobile imaging robot A1000 constantly analyzes the image of the imaging unit A1001 using the person detection unit A1002. Here, it is assumed that the person detection unit A1002 detects a worker U1.

As illustrated in FIG. 9, since the worker U1 is detected, the mobile imaging robot A1000 is stopped by the control instruction reception unit A1004. Then, the mobile imaging robot A1000 captures an image for a certain period of time by the imaging unit A1001. It is assumed that the photographing by the imaging unit A1001 is photographing from the side or the distance of the worker, and it is difficult to grasp the work content of the worker U1 and the situation of an assembly part A2001 from the captured image.

Next, the imaging unit A1001 provides the captured image to the imaging assistance system 100 as an input image. The imaging assistance system 100 analyzes the input image and estimates the position, size, and shape of the assembly part A2001 from the motion of the hand of the worker U1. The imaging assistance system 100 determines an imaging position S1 and the posture at which both the positions are within the imaging angle of view in consideration of the position of the worker U1 and the estimated position, shape, and size of the assembly part A2001.

As illustrated in FIG. 9, the mobile imaging robot A1000 instructs the control instruction reception unit A1004 on the determined imaging position and posture, and moves to the imaging position S1. As illustrated in FIG. 10, in a case where the mobile imaging robot A1000 moves to the imaging position S1, both the worker U1 and the assembly part A2001 are included in the same angle of view V1 to perform imaging.

### Third Example Embodiment

### Imaging Assistance System

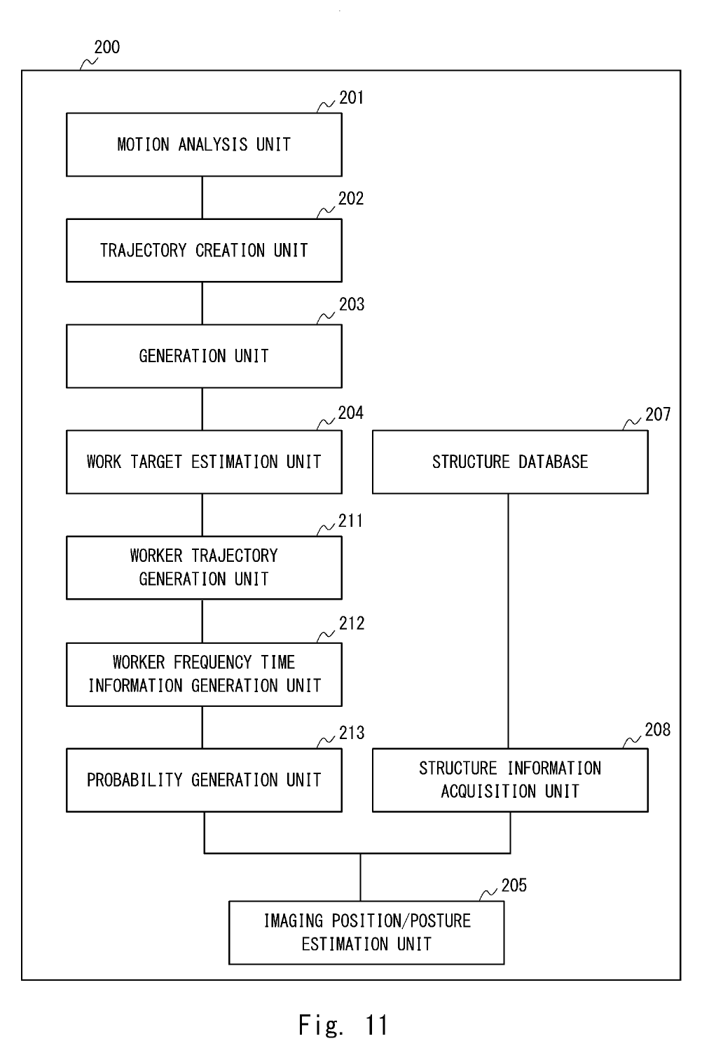

Hereinafter, a configuration of an imaging assistance system according to the present disclosure will be described with reference to FIG. 11. FIG. 11 is a block diagram illustrating the imaging assistance system according to the present disclosure. As illustrated in FIG. 11, the imaging assistance system 100 includes a motion analysis unit 201, a trajectory creation unit 202, a generation unit 203, a work target estimation unit 204, a worker trajectory generation unit 211, a worker frequency information generation unit 212, a probability generation unit 213, a structure database 207, a structure information acquisition unit 208, and an imaging position/posture determination unit 105. Hereinafter, each configuration will be described in detail. Then, the operation of the imaging assistance system 100 will be described.

Since the motion analysis unit 201, the trajectory creation unit 202, the generation unit 203, and the work target estimation unit 204 are similar to the motion analysis unit 101, the trajectory creation unit 102, the generation unit 103, and the work target estimation unit 104 illustrated in FIG. 3, the description thereof will be omitted.

### Worker Trajectory Generation Unit

The worker trajectory generation unit 211 creates a movement trajectory of the worker from the image. Similarly to the trajectory creation unit 202, the worker trajectory generation unit 211 creates the movement trajectory of the worker from the analysis result of the motion analysis unit 201.

### Generation of Worker Frequency Information

The worker frequency information generation unit 212 generates worker frequency time information including the frequency at which the worker is positioned at each position included in the movement trajectory of the worker and the time during which the worker is positioned at each position. The worker frequency information generation unit 212 generates worker frequency time information in the movement trajectory of the worker similarly to the generation unit 203.

### Probability Generation Unit

The probability generation unit 213 generates a stay probability of the worker on the movement trajectory based on the worker frequency time information. The stay probability indicates a probability that the worker is positioned on the movement trajectory of the worker. The probability generation unit 213 calculates the stay probability by dividing the frequency at which the worker is positioned at each position included in the movement trajectory of the worker by the total value.

For example, it is assumed that the worker moves in the order of the positions A, B, C, and A, and the movement trajectory of the worker connecting the positions A, B, and C is drawn. In this case, since the worker is positioned at the position A twice, the probability generation unit 213 calculates that the stay probability of the worker at the position A is 50%.

In this case, the probability generation unit 213 calculates that the stay probability of the worker at each of the positions B and C is 25% because the worker is positioned at each of the positions B and C once.

### Structure Database, Structure Information Acquisition Unit

The structure database 207 is a database that stores information regarding a structure in a space where a worker works. The space where the worker works is also a space in an area where the mobile body performs photographing.

The structure database 207 includes information such as a position, a size, and a shape of a structure. The structure database 207 includes 3D model information for enabling a structure to be arranged in a three-dimensional space. The structure information acquisition unit 208 acquires, from the structure database 207, information regarding a structure in a space where a worker works.

### Imaging Position/Posture Determination Unit

An imaging position/posture determination unit 205 determines a plurality of imaging candidate positions such that the work target estimated by the work target estimation unit 204 and the worker are included in the same angle of view. The imaging position/posture determination unit 205 creates an imaging candidate position list including a plurality of imaging candidate positions. The plurality of imaging candidate positions are, for example, the imaging candidate positions S11 to S18 illustrated in FIG. 6. The imaging candidate position list is, for example, a list including the imaging candidate positions S11 to S18 illustrated in FIG. 6.

### Consideration of Structure

The imaging position/posture determination unit 205 determines whether there is a structure at a position of a plurality of imaging candidate positions based on the information regarding the structure acquired from the structure database 207. In a case where there is a structure at the imaging candidate position, the imaging position/posture determination unit 205 excludes the imaging candidate position from the imaging candidate position list.

The imaging position/posture determination unit 205 determines whether a structure is positioned between each imaging candidate position in the imaging candidate position list and the worker and the work target. For example, the imaging position/posture determination unit 205 provides a straight line between each imaging candidate position in the imaging candidate position list and the worker and the work target. Then, the imaging position/posture determination unit 205 determines whether the structure is positioned on the straight line. In a case where the structure is positioned on the straight line, the imaging position/posture determination unit 205 excludes the imaging candidate position from the imaging candidate position list. Then, the imaging position/posture determination unit 205 determines one imaging position from the imaging candidate position list as an imaging position of the camera of the mobile body.

In the above description, the example has been described in which the imaging position/posture determination unit 205 excludes the imaging candidate position where the structure is positioned on the straight line from the imaging candidate position list, and determines one imaging position from the imaging candidate position list as the imaging position by the camera of the mobile body. However, the present disclosure is not limited thereto, and the imaging position/posture determination unit 205 may determine the imaging position of the mobile body as follows. The imaging position/posture determination unit 205 may determine the imaging position from the imaging candidate position list such that the area where the structure overlaps the worker and the work target is reduced.

Although the case of determining the imaging position has been described here, the imaging position/posture determination unit 205 may determine the posture such that the area where the structure overlaps the worker and the work target is reduced. That is, the imaging position/posture determination unit 205 may determine the imaging position and the posture from the imaging candidate position list such that the area where the structure overlaps the worker and the work target is reduced.

### Consideration of Worker's Movement

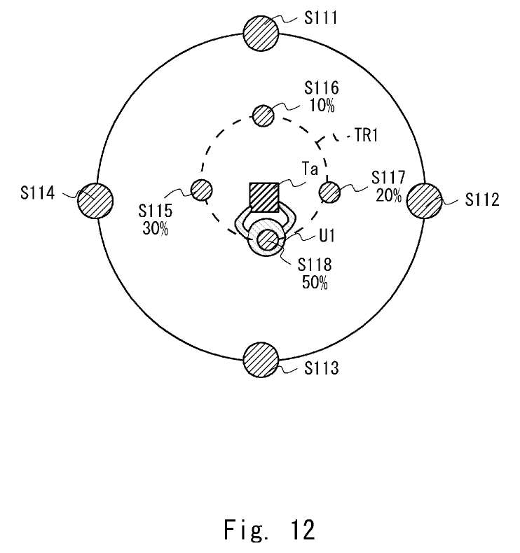

The imaging position/posture determination unit 205 may determine the imaging position and the posture such that the area where the worker overlaps the work target is reduced based on the stay probability of the worker. A specific description will be given with reference to FIG. 12. FIG. 12 is a diagram illustrating imaging candidate positions and trajectories of a worker.

In FIG. 12, imaging candidate positions S111 to S114 are illustrated. In FIG. 12, a trajectory TR1 of a worker U1 is illustrated. In FIG. 12, in a case where the camera is directed to the worker U1 and a work target Ta from the imaging candidate positions S111 to S114, the stay probabilities of the worker U1 at the positions S115 to S118 on the trajectory TR1 are 30%, 10%, 20%, and 50%.

First, the imaging position/posture determination unit 205 determines a plurality of imaging candidate positions at which the work target Ta estimated by the work target estimation unit 204 and the worker U1 are included in the same angle of view, and creates an imaging candidate position list including the plurality of imaging candidate positions S111 to S114.

Next, in a case where the photographing is performed from the imaging candidate positions S111 to S114, the imaging position/posture determination unit 205 determines the imaging candidate position S111 having the smallest stay probability of the worker U1 as the imaging position.

That is, the possibility that the worker U1 is positioned at the point S116 from the imaging candidate position S111 is 10%, and thus, the possibility that the work target Ta is hidden by the worker U1 is low. Therefore, the imaging position/posture determination unit 205 determines the imaging candidate position S111 as the imaging position. With such a configuration, it is possible to capture an image while preventing the work target Ta from being hidden by the worker U1 who is moving.

Here, the description has been given with the same posture of the camera directed from each of the imaging candidate positions S111 to S114 to the worker U1 and the work target Ta. The imaging position/posture determination unit 205 may determine the posture such that the area where the worker overlaps the work target is reduced based on the stay probability of the worker by a similar procedure. That is, the imaging position/posture determination unit 205 may determine the imaging position and the posture such that the area where the worker overlaps the work target is reduced based on the stay probability of the worker.

The imaging position/posture determination unit 205 may determine the imaging position as follows.

The imaging position/posture determination unit 205 performs ray tracing on the worker U1 and the work target Ta from the imaging candidate positions S111 to S114. Then, in a case where the light beam collides with the worker U1, the imaging position/posture determination unit 205 calculates an evaluation value multiplied by the stay probability. The imaging position/posture determination unit 205 selects an imaging candidate position having the smallest evaluation value from among the plurality of imaging candidate positions, and determines the imaging position and the posture.

In the above example, the imaging position/posture determination unit 205 has been described about each of the case where the structure is considered and the case where the movement of the worker is considered. The imaging position/posture determination unit 205 may determine the imaging position and the posture, based on the stay probability of the worker, such that the area where the worker overlaps the work target is reduced, and also the area where the structure overlaps the worker and the work target is reduced. That is, the imaging position/posture determination unit 205 may be configured to determine the imaging position and the posture in consideration of both the movement of the structure and the movement of the worker.

### Imaging Assistance Method

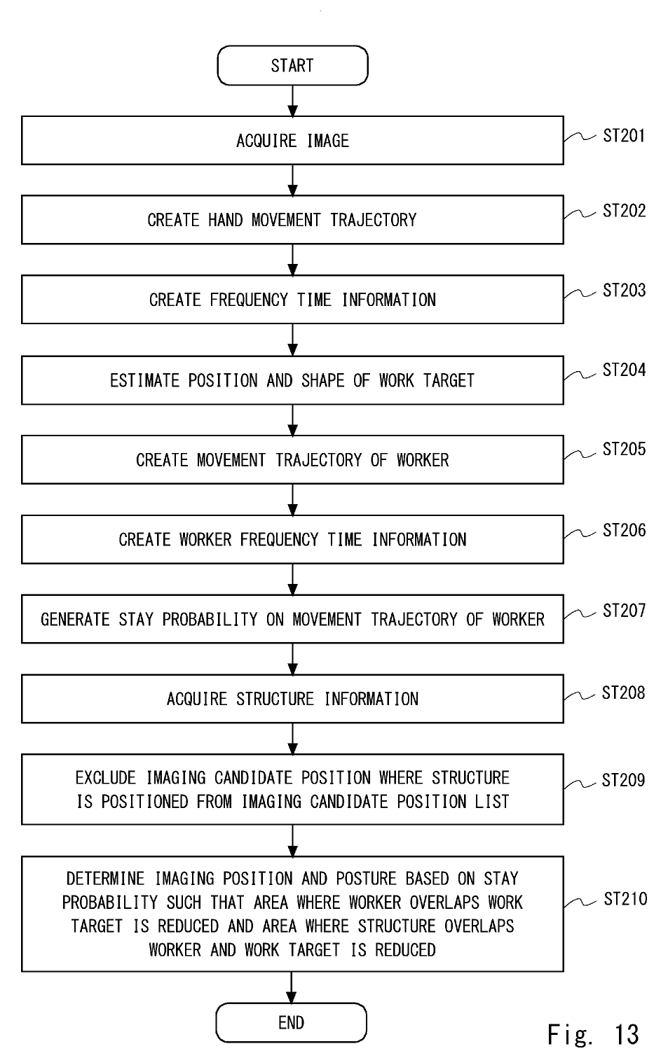

Next, an imaging assistance method according to the present disclosure will be described. FIG. 13 is a flowchart illustrating an imaging assistance method according to the present disclosure. Since steps ST201 to ST204 are similar to steps ST101 to ST104 in FIG. 7, the description thereof is omitted.

The worker trajectory generation unit 211 creates a movement trajectory of the worker from the analysis result of the motion analysis unit 201 (step ST205). Next, the worker frequency information generation unit 212 generates worker frequency time information including the frequency at which the worker is positioned at each position included in the movement trajectory of the worker and the time during which the worker is positioned at each position (step ST206). In steps ST205 and ST206, the “hand of the worker” in steps ST201 and ST202 is the “worker”.

Next, the probability generation unit 213 generates a stay probability of the worker on the movement trajectory based on the worker frequency time information (step ST207). For example, the probability generation unit 213 calculates the stay probability by dividing the frequency at which the worker is positioned at each position included in the movement trajectory of the worker by the total value.

Next, the structure information acquisition unit 208 acquires information regarding the structure in the space where the worker works from the structure database 207 (step ST208). For example, the structure information acquisition unit 208 acquires information such as the position, size, and shape of the structure.

Next, the imaging position/posture determination unit 205 excludes the imaging candidate position where the structure is positioned from the imaging candidate position list (step ST209).

Next, the imaging position/posture determination unit 205 determines the imaging position and the posture, based on the stay probability of the worker, such that the area where the worker overlaps the work target is reduced, and also the area where the structure overlaps the worker and the work target is reduced (step ST210).

As described above, in the imaging assistance method according to the present disclosure, the imaging position and posture are determined based on the stay probability of the worker and the information regarding the structure. With such a configuration, in the imaging assistance method according to the present disclosure, it is possible to suppress the work target from being hidden by the worker, and to suppress the worker and the work target from being hidden by the structure.

### Configuration Example

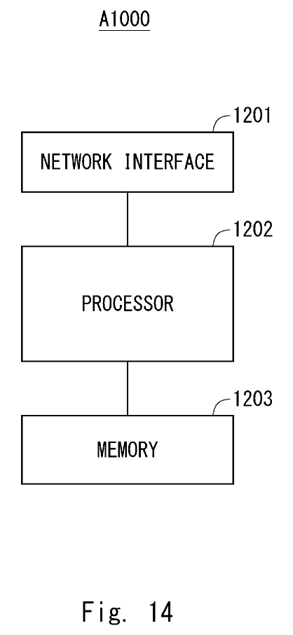

FIG. 14 is a block diagram illustrating a configuration example of a mobile body according to the present disclosure. FIG. 14 is a block diagram illustrating a configuration example of the above-described mobile body (hereinafter, referred to as a mobile body 1000 and the like). Referring to FIG. 14, the mobile body 1000 and the like include a network interface 1201, a processor 1202, and a memory 1203.

The network interface 1201 may be used to communicate with network nodes. The network interface 1201 may include, for example, a network interface card (NIC) conforming to IEEE 802.3 series. IEEE represents Institute of Electrical and Electronics Engineers.

The processor 1202 reads and executes software (computer program) from the memory 1203 to perform processing of the mobile body 1000 or the like described using the flowcharts in the above-described example embodiments. The processor 1202 may be, for example, a microprocessor, a micro processing unit (MPU), or a central processing unit (CPU). The processor 1202 may include a plurality of processors.

The memory 1203 is constituted by a combination of a volatile memory and a nonvolatile memory. The memory 1203 may include a storage arranged away from the processor 1202. In this case, the processor 1202 may access the memory 1203 via an Input/Output (I/O) interface (not illustrated).

In the example in FIG. 14, the memory 1203 is used to save software modules. The processor 1202 can perform the processing of the mobile body 1000 or the like described in the above-described example embodiments by reading and executing these software modules from the memory 1203.

As described with reference to FIG. 14, each of the processors included in the mobile body 1000 and the like executes one or a plurality of programs including instructions for causing a computer to perform the algorithm described with reference to the drawings.

In the above-described example, the program includes instructions (or software codes) for causing the computer to perform one or more functions described in the example embodiments, in a case of being read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technique, a CD-ROM, a digital versatile disc (DVD), a Blu-ray (registered trademark) disc or any other optical disc storage, and a magnetic cassette, a magnetic tape, a magnetic disk storage, or any other magnetic storage device. The program may be transmitted through a transitory computer-readable medium or a communication medium. The program is included in the program product. As an example and not by way of limitation, the transitory computer-readable medium or the communication medium includes propagated signals in electrical, optical, acoustic, or any other form.

Although the present disclosure has been described in accordance with the above example embodiment, the present disclosure is not limited to the configuration of the above example embodiment, and includes various modifications, corrections, and combinations that can be made by those skilled in the art within the scope of the claims of the present application.

Each drawing is merely illustrative for describing one or more example embodiments. Each of the drawings is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings for describing illustrative example embodiments are not necessarily mandatory, and some features or steps may be omitted. The order of the steps described in any one of the drawings may be changed as appropriate.

Some or all of the above example embodiments can also be described as the following Supplementary Notes, but are not limited to the following Supplementary Notes.

### Supplementary Note 1

An imaging assistance system for assisting image capturing by a camera of a mobile body, the imaging assistance system including:

a trajectory creation unit that creates a movement trajectory of a hand of a worker from an image;

a generation unit that generates frequency time information including a frequency at which the hand of the worker is positioned at each position included in a movement trajectory of the hand and a time during which the hand of the worker is positioned at the position;

a work target estimation unit that estimates a position and a shape of a work target of the worker based on the frequency time information; and

an imaging position/posture determination unit that determines an imaging position and a posture of the mobile body by the camera in such a way that the worker and the work target are included in a same angle of view.

### Supplementary Note 2

The imaging assistance system according to Supplementary Note 1, in which the imaging position/posture determination unit further determines the imaging position and the posture in such a way that an area where the worker and the work target overlap each other is reduced.

### Supplementary Note 3

The imaging assistance system according to Supplementary Note 2, in which the imaging position/posture determination unit is configured to execute:

setting the imaging position at which the worker and the work target are included in a same angle of view as an imaging candidate position;

calculating a capturing range of the worker and the work target by irradiating the worker and the work target with a light beam from the camera of the mobile body at each imaging candidate position; and

determining the imaging position from the imaging candidate positions in such a way that an area where the worker and the work target overlap each other is reduced.

### Supplementary Note 4

The imaging assistance system according to Supplementary Note 1, further including:

a worker trajectory creation unit that creates a movement trajectory of a worker from the image;

a worker frequency time information generation unit that generates worker frequency time information including a frequency at which the worker is positioned at each position included in the movement trajectory of the worker and a time at which the worker is positioned at the position; and

a probability generation unit that generates a stay probability on the movement trajectory of the worker based on the worker frequency time information,

in which the imaging position/posture determination unit is further configured to execute determining the imaging position and the posture based on the stay probability of the worker in such a way that an area where the worker overlaps the work target is reduced.

### Supplementary Note 5

The imaging assistance system according to Supplementary Note 1 or 4, further including a structure information acquisition unit that acquires information regarding a structure in a space where a worker works,

in which the imaging position/posture determination unit is further configured to execute determining the imaging position and the posture in such a way that an area where the structure overlaps the worker and the work target is reduced.

### Supplementary Note 6

The imaging assistance system according to Supplementary Note 1 or 2, in which

the generation unit is further configured to execute accumulating the frequency included in the frequency time information for each divided space obtained by dividing a space, and

the work target estimation unit is further configured to execute estimating a position and a shape of a work target of the worker by extracting the divided space in which the accumulated frequency is a predetermined value or more.

### Supplementary Note 7

The imaging assistance system according to Supplementary Note 1 or 2, in which

the generation unit is further configured to execute accumulating the time included in the frequency time information for each divided space obtained by dividing a space, and

the work target estimation unit is further configured to execute estimating a position and a shape of a work target of the worker by extracting the divided space in which the accumulated time is a predetermined value or more.

### Supplementary Note 8

The imaging assistance system according to Supplementary Note 1 or 2, in which the mobile body is a self-propelled conveyance robot or a drone.

### Supplementary Note 9

An imaging assistance method for assisting image capturing by a camera of a mobile body, the imaging assistance method causing a computer to execute:

creating a movement trajectory of a hand of a worker from an image;

generating frequency time information including a frequency at which the hand of the worker is positioned at each position included in a movement trajectory of the hand and a time during which the hand of the worker is positioned at the position;

estimating a position and a shape of a work target of the worker based on the frequency time information; and

determining an imaging position and a posture of the mobile body by the camera in such a way that the worker and the work target are included in a same angle of view.

### Supplementary Note 10

An imaging assistance program for assisting image capturing by a camera of a mobile body, the imaging assistance program causing a computer to execute:

creating a movement trajectory of a hand of a worker from an image;

generating frequency time information including a frequency at which the hand of the worker is positioned at each position included in a movement trajectory of the hand and a time during which the hand of the worker is positioned at the position;

estimating a position and a shape of a work target of the worker based on the frequency time information; and

determining an imaging position and a posture of the mobile body by the camera in such a way that the worker and the work target are included in a same angle of view.

Some or all of the elements (such as components and functions, for example) described in Supplementary Notes 2 to 8 dependent on Supplementary Note 1 may be dependent on Supplementary Notes 9 and 10 as well with similar dependent relationships to those of Supplementary Notes 2 to 8. Some or all of the elements described in any supplementary note may be applied to various types of hardware, software, recording means for recording software, systems, and methods.

1. An imaging assistance system for assisting image capturing by a camera of a mobile body, the imaging assistance system comprising:
at least one memory storing instructions; and
at least one processor configured to execute the instructions to:
create a movement trajectory of a hand of a worker from an image;
generate frequency time information including a frequency at which the hand of the worker is positioned at each position included in a movement trajectory of the hand and a time during which the hand of the worker is positioned at the position;
estimate a position and a shape of a work target of the worker based on the frequency time information; and
determine an imaging position and a posture of the mobile body by the camera in such a way that the worker and the work target are included in a same angle of view.

2. The imaging assistance system according to claim 1, wherein the at least one processor is further configured to execute the instructions to determine the imaging position and the posture in such a way that an area where the worker and the work target overlap each other is reduced.

3. The imaging assistance system according to claim 2, wherein the at least one processor is further configured to execute the instructions to:
set the imaging position at which the worker and the work target are included in a same angle of view as an imaging candidate position;
calculate a capturing range of the worker and the work target by irradiating the worker and the work target with a light beam from the camera of the mobile body at each imaging candidate position; and
determine the imaging position from the imaging candidate positions in such a way that an area where the worker and the work target overlap each other is reduced.

4. The imaging assistance system according to claim 1, wherein the at least one processor is further configured to execute the instructions to:
create a movement trajectory of a worker from the image;
generate worker frequency time information including a frequency at which the worker is positioned at each position included in the movement trajectory of the worker and a time at which the worker is positioned at the position; and
generate a stay probability on the movement trajectory of the worker based on the worker frequency time information,
wherein the at least one processor is further configured to execute the instructions to determine the imaging position and the posture based on the stay probability of the worker in such a way that an area where the worker overlaps the work target is reduced.

5. The imaging assistance system according to claim 1, wherein the at least one processor is further configured to execute the instructions to acquire information regarding a structure in a space where a worker works,
wherein the at least one processor is further configured to execute the instructions to determine the imaging position and the posture in such a way that an area where the structure overlaps the worker and the work target is reduced.

6. The imaging assistance system according to claim 1, wherein the at least one processor is further configured to execute the instructions to accumulate the frequency included in the frequency time information for each divided space obtained by dividing a space, and
wherein the at least one processor is further configured to execute the instructions to estimate a position and a shape of a work target of the worker by extracting the divided space in which the accumulated frequency is a predetermined value or more.

7. The imaging assistance system according to claim 1, wherein the at least one processor is further configured to execute the instructions to accumulate the time included in the frequency time information for each divided space obtained by dividing a space, and
wherein the at least one processor is further configured to execute the instructions to estimate a position and a shape of a work target of the worker by extracting the divided space in which the accumulated time is a predetermined value or more.

8. The imaging assistance system according to claim 1, wherein the mobile body is a self-propelled conveyance robot or a drone.

9. An imaging assistance method for assisting image capturing by a camera of a mobile body, the imaging assistance method causing a computer to execute:
creating a movement trajectory of a hand of a worker from an image;
generating frequency time information including a frequency at which the hand of the worker is positioned at each position included in a movement trajectory of the hand and a time during which the hand of the worker is positioned at the position;
estimating a position and a shape of a work target of the worker based on the frequency time information; and
determining an imaging position and a posture of the mobile body by the camera in such a way that the worker and the work target are included in a same angle of view.

10. A non-transitory computer readable medium for assisting image capturing by a camera of a mobile body storing a program for causing a computer to execute processing of:
creating a movement trajectory of a hand of a worker from an image;
generating frequency time information including a frequency at which the hand of the worker is positioned at each position included in a movement trajectory of the hand and a time during which the hand of the worker is positioned at the position;
estimating a position and a shape of a work target of the worker based on the frequency time information; and
determining an imaging position and a posture of the mobile body by the camera in such a way that the worker and the work target are included in a same angle of view.
